(19) United States
(12) Patent Application Publication
(10) Pub. No.: US 2017/0145897 A1
(43) Pub. Date: May 25, 2017

(54) TANK FOR COOLANT LIQUID OF A HEAT ENGINE AND FOR ENGINE AND/OR TRANSMISSION LUBRICANT, AND CIRCUIT INCLUDING SAME

(71) Applicant: HUTCHINSON, Paris (FR)

(72) Inventors: Laurent COLDRE, La Neuville Sur Essonne (FR); Benjamin SWOBODA, Bois Le Roi (FR)

(73) Assignee: HUTCHINSON, Paris (FR)

(21) Appl. No.: 15/113,715

(22) PCT Filed: Jan. 30, 2014
(86) PCT No.: PCT/FR2014/050167

§ 371 Date: Feb. 3, 2017

(51) Int. Cl. F01P 11/02; F01P 3/20; F01M 5/02; F16H 57/04; F01M 5/00

(52) U.S. Cl. CPC F01P 11/029; F16H 57/045; F16H 57/0475; F16H 57/0417; F16H 57/0413; F01M 5/001; F01M 5/021; F01P 3/20; F01M 2011/0095

(57) ABSTRACT

A tank stores a coolant liquid and an engine and/or transmission lubricant for a motor vehicle heat engine, as well as a circuit for the cooling and heat regulation of that engine.

The tank has a thermally insulating outer wall including an inlet and an outlet for this liquid, and inside the wall, it comprises heating means that are able to preheat this liquid for the cold engine start of the vehicle.

The tank further includes a first compartment for this liquid that is provided with said inlet and said outlet, and at least one other compartment that is appropriate for storing an engine or transmission lubricant and that is separated from the first compartment by a tight partition in a lower zone of the first compartment, these compartments each containing at least one local heating means as heating means.

The present invention relates to a storage tank for a coolant liquid and an engine and/or transmission lubricant for a motor vehicle heat engine, as well as a circuit for the cooling and heat regulation of that engine. The invention generally applies to the control of the temperature of the coolant liquid and the engine and/or transmission lubricant for all motorized vehicles including an internal combustion heat engine (in particular for land vehicles, which may be automobiles, for example passenger vehicles and/or heavy trucks, rail, maritime or river vehicles), as well as hybrid vehicles further incorporating an electric engine or a storage battery in particular for preheating the heat engine of the hybrid vehicle (with startup on electric engine, preheating of the heat engine, then startup of the heat engine), to preheat the passenger compartment or any other member or system of a vehicle (for example, the battery or the electronic systems).

It is known from documents U.S. Pat. No. 6,102,103 and U.S. Pat. No. 8,191,618 to reheat the coolant liquid of a motor vehicle heat engine, for the cold engine start of the vehicle, using a tank with thermally insulating outer walls filled with phase change materials (PCM) in contact with a heat exchanger with tubes provided with fins.

One major drawback of the existing cooling and heat regulation circuits lies in the absence of means allowing simple and easy control of the temperature of the engine and transmission lubricant used for heat engines or to reheat those lubricants at the same time as the coolant liquid.

One aim of the present invention is to propose a tank suitable for storing a coolant liquid of a heat engine of a motor vehicle within a cooling and heat regulation circuit of the engine, this tank in particular resolving this drawback especially by making it possible to keep the coolant liquid and the engine and/or transmission lubricants at a homogenous temperature and to preheat these fluids to one or several predetermined temperature(s) whether the engine is hot or cold, the tank being defined by a thermally insulating outer wall including an inlet and an outlet for this liquid, the tank comprising heating means inside the wall that are able to preheat this liquid for the cold engine start of the vehicle.

To that end, a tank according to the invention comprises a first compartment for the coolant liquid that is provided with said inlet and said outlet, and at least one other compartment that is appropriate for storing a lubricant of the engine or a transmission lubricant (i.e., another component for engine oil and/or another separate compartment for transmission oil) and that is separated from the first compartment by a tight partition in a lower zone of said first compartment, said first compartment and said at least one other compartment each containing at least one local heating means as heating means.

A “tight partition” refers, within the meaning of the present description, to a partition that is completely tight with respect to the various fluids situated on either side of said partition. Concretely, the tight partition separating said at least one other compartment and said first compartment is tight with respect to the coolant liquid and the engine or transmission lubricant.

According to one advantageous example embodiment of the invention, said at least one local heating means comprises at least one phase change material (PCM), having specified that this local heating means may vary from one compartment to another.

It will, however, be noted that other local heating means can be used as an alternative or in addition to PCMs, for example by chemical means and/or by refractory materials, non-limitingly.

Phase change materials usable in a tank according to the invention include, but are not limited to, fatty acids, such as stearic acid, having specified that it is possible to use a mixture of several saturated and/or unsaturated fatty acids for example comprising stearic acid. It will, however, be noted that PCMs for example chosen from among hydrated or metal salts, paraffins and/or polyolefins can also be used.

It will be noted that the inclusion of this partitioned single-piece tank according to the invention in a cooling and heat regulation circuit of an engine allows a satisfactory heat regulation of the reheating of the coolant liquid, the engine lubricant and/or the transmission lubricant when restarting the vehicle using this heat engine. Indeed, after the heat engine has been stopped, the coolant liquid remains, for a certain length of time, at a relatively high temperature of approximately 70 to 90° C., which causes the or each molten PCM to release heat into the corresponding fluid, which is thus already relatively hot when the heat engine is restarted. This in particular results in a reduction of the carbon dioxide emissions in the exhaust and fuel overconsumption, compared with what is observed with a cold engine. Likewise, reheating the engine oil and/or transmission oil allows optimized operation of the heat engine of the vehicle.

It will also be noted that tank according to the invention may incorporate auxiliary heating or preheating means for the coolant liquid, and optionally engine lubricant and/or lubricant other than said at least one phase change material, these auxiliary means for example comprising electric resistances directly housed in said first compartment to (pre)heat the coolant liquid and/or in the other compartment(s) to (pre)heat the engine lubricant and/or the transmission lubricant.

According to another feature of the invention, said first compartment may extend at least partially along a substantially vertical direction and said at least one other compartment may extend globally below said first compartment along a substantially horizontal direction.

According to one particularly advantageous embodiment of the invention, the tank comprises two other said compartments that are respectively made up of a first other compartment suitable for storing said engine lubricant and second other compartment suitable for storing said transmission lubricant, which each contain said at least one phase change material and which are separated from one another by another tight partition.

As explained above in reference to said tight partition, said other tight partition is tight with respect to both the transmission lubricant and the engine lubricant.

It will be noted that the integration of a tank according to the invention in the engine compartment makes it possible to keep the quantity of fluids (i.e., engine lubricant and transmission lubricant) at a quasi-constant volume, relative to an engine compartment not equipped with this tank according to the invention.

Still more advantageously, said first other compartment and/or said second other compartment can be separated from said first compartment by said tight partition, which is made up of a lower face of said first compartment, the tank being able globally to have an L shape or an upside down T shape.

Preferably, said other tight partition is substantially perpendicular to said first tight partition.

According to another feature of the invention, said tight partition and said other tight partition may each be suitable for producing thermal bridges so as to keep the coolant liquid, said engine lubricant and said transmission lubricant at least at one homogenous temperature.

Advantageously, said tight partition and said other tight partition can have heat permeabilities suitable for producing these thermal bridges (i.e., which are obtained through the design and materials of the partitions) and/or heat pipes crossing through these partitions (i.e., these thermal bridges are obtained by these heat pipes, which allow the exchange of heat between compartments).

According to another feature of the invention, said first compartment and said at least one other compartment can respectively be provided with support structures for said at least one phase change material, these support structures being able to be secured to said outer wall and being compatible with said coolant liquid and with said engine lubricant and/or transmission lubricant.

Advantageously, said support structures can comprise hollow tubes with closed ends containing said at least one phase change material.

According to another feature of the invention, the tank may further comprise means forming an expansion and degassing vessel that are situated in an upper zone of the tank formed above said first compartment.

According to another feature of the invention, said outer wall of the tank may comprise two enclosures and a super heat insulating aerogel arranged between these enclosures and optionally combined with a vacuum.

As an alternative to this aerogel, it will be noted that the thermal insulation may be done between these two enclosures by a vacuum, a simple heat insulator and/or a radiation-reflecting coating.

It will, however, be noted that other super insulating outer wall structures may be used, in order for the coolant liquid, the engine lubricant and optionally the transmission lubricant to be completely thermally insulated from the environment outside the tank.

Advantageously, said outer wall may have, at least in part, a rounded cross-section, for example circular, giving it a geometry of revolution (e.g., cylindrical or spherical).

It will be noted that this particular geometry of the tank according to the invention advantageously makes it possible to give it satisfactory strength with respect to the negative pressures resulting from a suction or a vacuum.

A circuit according to the invention for the cooling and heat regulation of a heat engine of a motor vehicle essentially comprises the heat engine, a thermostatic case connected to the heating system, a coolant liquid tank connected by a loop to said engine and said case, and a radiator of said engine, and the circuit is characterized in that the tank is as defined above.

According to another feature of the invention, said first compartment may be located behind and over substantially the entire height of the heat engine.

According to another feature of the invention, said at least one other compartment may be located below and over at least part of the length of the heat engine.

The fluids stored in the tank according to the invention may reach their container by gravity, movement members such as lifting pumps being able to be used if applicable to place them back in their respective circuits.

As indicated in the preamble of the present description, it will be noted that the coolant liquid stored in a tank according to the invention and circulating in said cooling and heat regulation circuit may further be used to cool an electric engine or a storage battery equipping a hybrid engine vehicle.

Other features, advantages and details of the present invention will emerge from reading the following description of several example embodiments of the invention, provided as an illustration and non-limitingly, the description being done in reference to the attached drawings, in which:

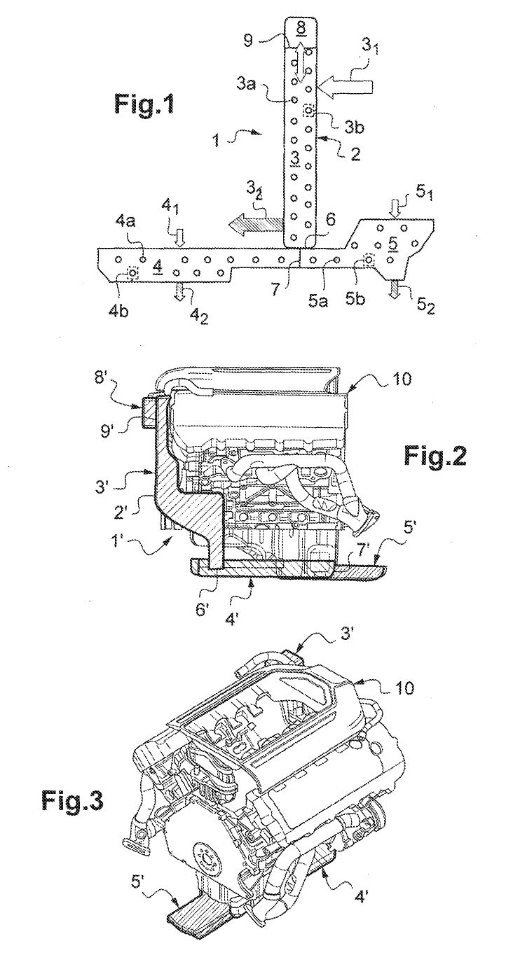

FIG. 1 is a vertical diagrammatic sectional view in a longitudinal plane of a motor vehicle extending from the back to the front of its engine compartment, of a tank according to one example of the invention comprising a first compartment and two other adjacent compartments;

FIG. 2 is a (left) side view of the engine compartment according to one alternative of the invention as shown in FIG. 3,

FIG. 3 is a side perspective and top view of the engine compartment of FIG. 2,

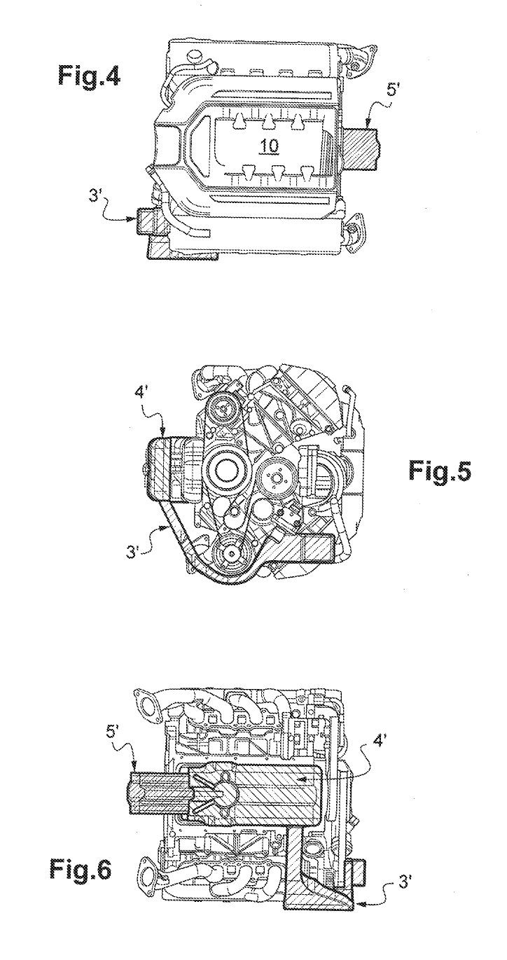

FIG. 4 is a top view of the engine compartment of FIG. 3,

FIG. 5 is a rear view of the engine compartment of FIG. 3,

FIG. 6 is a bottom view of the engine compartment of FIG. 3,

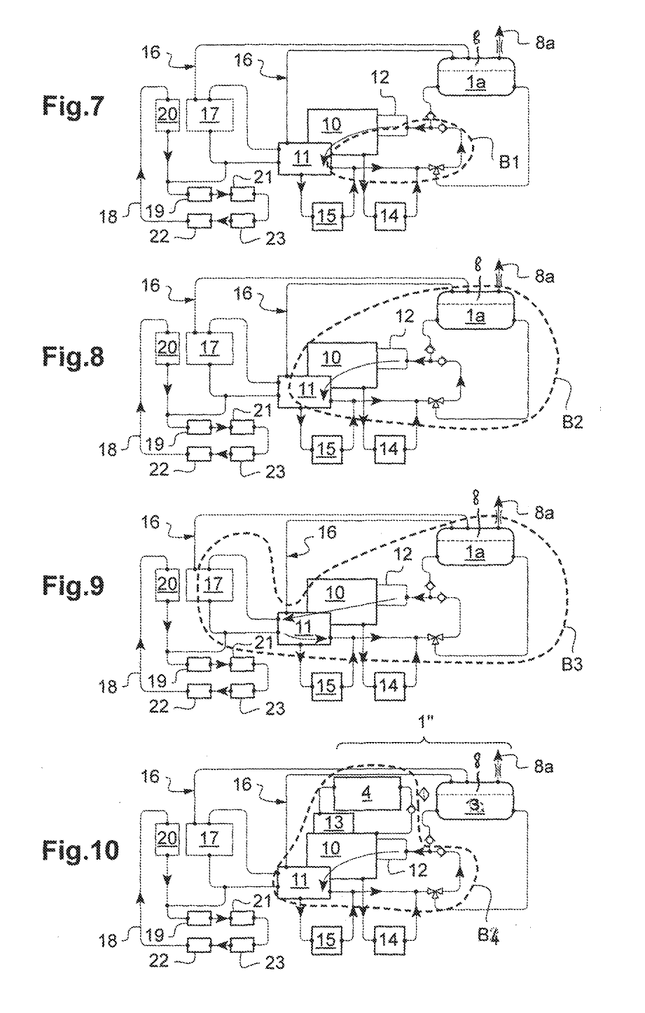

FIG. 7 is a block diagram of a cooling and heat regulation circuit, showing its operation upon startup with a cold liquid coolant tank,

FIG. 8 is a block diagram of a cooling circuit according to FIG. 7, showing its operation upon startup with this liquid coolant tank, which is hot and operating at a temperature below 100° C.,

FIG. 9 is a block diagram of a cooling circuit according to FIG. 7, showing its operation upon startup with the liquid coolant tank, which is hot and operating at a temperature above 100° C., and

FIG. 10 is a block diagram of a cooling circuit according to the invention, showing its operation upon startup with a tank according to the invention that is cold, as well as the heat regulation of the temperature of the engine lubricant procured by that tank.

The single-piece tank 1 illustrated in FIG. 1 is defined by an outer wall 2 substantially forming, in vertical section, an upside down asymmetrical T, with:

in its vertical part forming the downstroke of the T and situated at the back of the engine compartment inside the hood of the vehicle, a first compartment 3 containing the coolant liquid of the heat engine of the vehicle, having an inlet 3₁ and an outlet 3₂ for the liquid and providing local (pre)heating means 3a for said liquid, and

in its horizontal part forming the upside down apex of the T and extending from the back to the front of the engine compartment, two other compartments 4 and 5 that each have an inlet 4₁, 5₁ and an outlet 4₂, 5₂ and that are respectively provided with local (pre)heating means 4a and 5a including a rear compartment 4 containing the engine oil and a front compartment 5 containing the transmission oil.

Optionally, each inlet 4₁, 5₁ is provided with a solenoid valve to transfer the corresponding oil toward the compartment 4, 5 after the engine is stopped, by gravity. Also optionally, each outlet 4₂, 5₂ is provided with means for reinjecting the oil in question in the corresponding oil circuit, such as a lift pump provided with hoses.

According to the invention, the first compartment 3 is tightly separated by a tight horizontal partition 6 from the compartments 4 and 5, which are separated from one another by a tight vertical partition 7. The local (pre)heating means 3a, 4a, 5a for example each comprise one or more phase change materials (PCM) 3a, 4a, 5a optionally combined with other auxiliary (pre)heating means such as electric resistances. These PCMs 3a, 4a, 5a are advantageously supported by hollow tubes 3b, 4b, 5b with closed ends secured to the inner face of the wall 2 in each of the three tight compartments 3, 4 and 5 (these tubes receiving the PCMs are only partially shown in the diagram of FIG. 1).

Furthermore, the tank 1 in this example of FIG. 1 comprises an expansion and degassing vessel 8 that tops the upper compartment 3 and is separated from the latter by a partition 9.

In the alternative of FIGS. 2 to 6, the tank 1′ according to the invention has its outer wall 2′ somewhat substantially in the shape of an L (or an asymmetrical upside down T), as shown in FIG. 2, with, behind the engine compartment, the first compartment 3′ containing the coolant liquid that extends globally vertically from an expansion and degassing vessel 8′ to the compartment 4′ containing the engine oil (this expansion vessel A′ is separated from the compartment 3′ by a partition 9′). This compartment 4′ is separated from the compartment 3′ by a tight horizontal partition 6′ that extends globally horizontally from back to front up to the front compartment 5′ containing the transmission oil, from which it is separated by another substantially vertical tight partition 7′.

It will be noted that the transmission (comprising the gearbox) is not visible in the engine compartment of FIGS. 2 to 6 for clarity reasons, but that this transmission is in reality found in the extension of the engine 10 above the compartment 5′.

In reference to the example of FIG. 1 and the alternative according to the invention of FIGS. 2 to 6, all of the partitions 6, 7, 9 or 6′, 7′, 9′ comprised by the tank 1, 1′ are suitable for arranging thermal bridges (see the double-tipped arrows of FIG. 1) on either side of these partitions 6, 7, 9 or 6′, 7′, 9′ in order to keep the coolant liquid and the engine and transmission oils at a homogenous temperature.

It will be noted that the tank 1, 1′ according to the invention may have a variable shape other than those illustrated in FIGS. 1 to 6, the main point being that it is suited to the architecture of the engine while being directly integrated into the available space in the engine compartment.

FIGS. 7 to 10 show the main elements, members and loops of a fluid cooling and heat regulating circuit according to the example of the invention of FIG. 10, in which, in each of these four figures, the operating loop is shown by dashes and the elements are identified as follows:

Storage tank 1a for the coolant liquid only, also forming an expansion vessel 8;

Storage tank 1″ according to the invention for the coolant liquid with expansion vessel 8 and compartment 4 for the engine oil (FIG. 10);

Safety plug 8a (1.4 10⁵ Pa);

Heat engine 10;

Thermostatic case 11;

Pump 12 connected to the engine 10 for that liquid;

Oil pump 13 connected to the engine 10 (FIG. 10);

Turbocompressor 14 connected to the engine 10;

Heating system 15 connected to the case 11;

Degassing 16;

Radiator 17 of the engine 10 connected to the case 11; and

Loop 18 associated with an electric engine 19, with a radiator 20, an inverter 21, a “STT” 22 and a pump 23.

In FIG. 7, which illustrates the closed loop B1 operating upon startup of the vehicle with the storage tank 1a for the coolant liquid only in the cold state, one sees that this loop B1 is limited to the heat engine 10 and the thermostatic case 11.

In FIG. 8, which illustrates the closed loop B2 operating upon startup of the vehicle with the storage tank 1a for the coolant liquid only, which is hot, but at an operating temperature of less than 100° C., one sees that this loop B2 relates to the tank 1a in addition to the heat engine 10 and the thermostatic case 11.

In FIG. 9, which illustrates the closed loop B3 operating upon startup of the vehicle with the storage tank 1a for the coolant liquid only, which is hot and at an operating temperature of more than 100° C., one sees that this loop B3 relates to the radiator 17 of the engine 10 in addition to the tank 1a, the heat engine 10 and the case 11.

In FIG. 10, which illustrates the closed loop B4 operating upon startup of the vehicle with the tank 1″ according to the invention for the coolant liquid and the engine oil, which is cold, one sees that this loop B4 relates to the compartment 4 for the engine oil in addition to the heat engine 10 and the thermostatic case 11, which were only affected in FIG. 7.

It will lastly be noted in general that the hot engine/cold engine management is handled by the system onboard the vehicle, sub-systems such as solenoid valves or circulation/transfer pumps making it possible to circulate, or not circulate, the coolant liquid.

1. A tank suitable for storing a coolant liquid of a heat engine of a motor vehicle within a cooling and heat regulation circuit of the engine, the tank comprising a thermally insulating outer wall including an inlet and an outlet for the liquid, the tank comprising a heater inside the wall configured to preheat the liquid for the cold engine start of the vehicle, wherein the tank comprises a first compartment for the coolant liquid that is provided with said inlet and said outlet, and at least one other compartment configured for storing a lubricant of the engine or a transmission lubricant and that is separated from the first compartment by a tight partition in a lower zone of said first compartment, said first compartment and said at least one other compartment each containing at least one local heater.

2. The tank according to claim 1, wherein at least one local heater comprises at least one phase change material.

3. The tank according to claim 1, wherein said first compartment extends at least partially along a substantially vertical direction, and wherein the at least one other compartment extends globally below said first compartment along a substantially horizontal direction.

4. The tank according to claim 1, wherein the tank comprises two other said compartments that are respectively made up of a first other compartment suitable for storing said engine lubricant and second other compartment suitable for storing said transmission lubricant, which each contain said at least one phase change material and which are separated from one another by another tight partition.

5. The tank according to claim 4, wherein at least one of said first other compartment and said second other compartment are separated from said first compartment by said tight partition, which comprises a lower face of said first compartment, the tank globally having an L shape or an upside down T shape.

6. The tank according to claim 4, wherein said other tight partition is substantially perpendicular to said first tight partition.

7. The tank according to claim 4, wherein said tight partition and said other tight partition are configured to provide thermal bridges so as to keep the coolant liquid, said engine lubricant and said transmission lubricant at least at one homogenous temperature.

8. The tank according to claim 7, wherein said tight partition and said other tight partition have heat permeabilities that provide thermal bridges and/or heat pipes traversing these partitions.

9. The tank according to claim 1, wherein said first compartment and said at least one other compartment are respectively provided with support structures for said at least one phase change material, these support structures being secured to said outer wall and being compatible with said coolant liquid and with said engine lubricant and/or transmission lubricant.

10. The tank according to claim 9, wherein said support structures comprise hollow tubes with closed ends containing said at least one phase change material.

11. The tank according to claim 1, wherein the tank further comprises an expansion and degassing vessel situated in an upper zone of the tank formed above said first compartment.

12. The tank according to claim 1, wherein said outer wall of the tank comprises two enclosures and a super heat insulating aerogel arranged between these enclosures.

13. The tank according to claim 1, wherein said outer wall has, at least in part, a rounded cross-section, for example circular, giving it a geometry of revolution.

14. A circuit for the cooling and heat regulation of a heat engine of a motor vehicle, the circuit comprising the heat engine, a thermostatic case connected to a heating system, a coolant liquid tank connected by a loop to said engine and said case, and a radiator of said engine, wherein the tank is as defined according to claim 1.

15. The circuit according to claim 14, wherein said first compartment is located behind and over substantially the entire height of the heat engine.

16. The circuit according to claim 15, wherein at least one other compartment is located below and over at least part of the length of the heat engine.
